(19) United States
(12) Patent Application Publication
(10) Pub. No.: US 2014/0143111 A1
(43) Pub. Date: May 22, 2014

(54) MANAGEMENT SYSTEM FOR ELECTRONIC TRADE OF FINANCIAL INSTRUMENTS

(71) Applicant: Limited Liability Company "Simcord", (US)

(72) Inventor: Oleksandr KUD, Kharkov (UA)

(73) Assignee: LIMITED LIABILITY COMPANY "SIMCORD", Kharkiv (UA)

(21) Appl. No.: 13/849,239

(22) Filed: Mar. 22, 2013

(30) Foreign Application Priority Data
Nov. 16, 2012 (UA) A2012 13062

(51) Int. Cl. G06Q 40/04

(52) U.S. Cl. CPC G06Q 40/04
USPC 705/37

(57) ABSTRACT

Systems of non-cash financial operations, such as the management systems for electronic trade of financial instruments are described. The suggested management system for electronic trade of financial instruments is a hardware and software complex that includes interrelated Manager Module and User Module, containing the means of processing and transmitting/receiving Trading orders and the means of effecting Trading transactions. Hardware and software complex of the system additionally includes the Module of generation and analysis of trading orders (hereinafter—GATO Module), connected to the Manager Module and the User Module, providing the opportunity to receive, analyze and adjust Trading orders, generated by the Manager Module, generates Trading orders and translate them to the User Module for respective Trade transactions on the User's Account.

### RELATED APPLICATIONS

This application claims priority to Ukrainian Patent Application No. a2012 13062, filed Nov. 16, 2012, which is incorporated herein by reference in its entirety.

### FIELD OF THE INVENTION

The invention relates to the systems of non-cash financial operations, in particular, to the systems for managing electronic trade of financial instruments.

### BACKGROUND OF THE INVENTION

It is known various systems, used in the financial operations management. In particular, prior credit and financial management system in the investment environment, which contains the central device for processing and managing an investment fund, a device for issuing financial (credit) liabilities, a device for accepting financial (credit) liabilities, a device for processing and managing the financial (credit) liabilities fund management and a device for issuing payment instruments (RU Patent No. 22111535, IPC G06F17/60, G06F19/00, published May 20, 1998). The system is designed to receive credits and deposit available funds in financial institutions, using the system, and provides guarantees of receiving income at the expense of reducing investment risks of return of investments by the established date. The abovementioned system has narrow field of application and cannot be applied to the electronic trade of financial instruments.

Also known is a RiskMetrics system, which contains a device for data input, a device for accepting data on definite assets, in particular, on financial instruments, and on other essential features of financial instruments, on the transactions with these instruments, background data on the values of risk factors, devices and means of intermediary data storage and processing as well as devices of data output.

RiskMetrics system operates the following way. Information on the composition and the quantity of financial instruments, being in the investment portfolio, specifications of all financial instruments (major parameters—maturity date, dates and volumes of income payment, the payment currency etc.) are entered via the data input device. After which the structure of this investment portfolio is made as well as the schedule of amounts payable to the investor. Formed data are sent to the data storage module. In the storage module the data are complete with background and current information on prices for financial instruments and background values of the risk factors. Next, estimation of the current value of the mean square deviation (volatility) for each of the risk factors and values of correlation between different risk factors are made in the module of estimation of statistical values. Resulting data are sent to the module of scenarios estimation and returned to the data storage module. In the estimation module risk factor behavior scenarios estimation is carried basing on the rated statistical values. Results of estimations are sent to the module of complete analysis, where the estimation of probable cash flow is made for this portfolio. Rated data are entered into the module of complete risk estimation, where the aggregate risk analysis estimation is made for the investment portfolio under consideration. Evaluated risks are transmitted to the decision-making module, where based on the comparison of the risk data by other investment portfolios, or comparison of the data on limits (thresholds) of potential risks, the User makes decisions on effecting transactions on the market. This system solves the problem of lowering deal risks. However, as this system suggests decision—making on market transactions by the user, it cannot be extensively applied and is not always efficient. For example, electronic trade of financial instruments is carried out round the clock, therefore, the user does not always have an opportunity to make decisions independently a certain time. Moreover, even under the availability of information on potential risks, the User can make a mistake, and, consequently, bear financial risks of loss.

It is known a system, method and software for the centralized currency exchange. The system runs on the centralized processing server and there commercial banks, dealers and individual traders operate on the centralized currency exchange market, therewith:

the centralized processing server receives Trading orders, automatically selects and promotes Trading transactions, records and saves trading details, distributes reports on the performance of Trading transactions, receives information from providers, and sends Trading orders and commercial information to different information providers;

computer software is interactively connected to the centralized processing server and provides all users with a possibility to receive and display information from the centralized processing server on the effect of Trading transactions, and provides users with the information, received from the centralized processing server (US Patent No. US 2005/0283422).

### SUMMARY OF THE INVENTION

The key object of the invention is to create such management system for electronic trade of financial instruments, which, due to the introduction of the Module of generation and analysis of trading orders (hereinafter—GATO Module) enables automation of analysis and adjustment of the Trading orders, generated by the Manager, and automation of their translation to the User Module for effecting respective Trade transactions on the User's Account, with the same speed as could be under the translation of Trading orders without their processing in the GATO Module.

Another result of the suggested invention is the possibility to block, adjust and generate a Trading order, which, in turn, enables to lower the risk of potential loss of User's funds and increase his profits.

Furthermore, possibility to expand and alter the base of algorithms, which may be entered into the GATO Module, ensures adaptive and volatile features of the system as well as operative and accurate adjustment and blocking of Trading orders.

The established objective is achieved in the following way: the suggested management system for electronic trade of financial instruments, being a hardware and software complex that includes interrelated Manager and User Modules, containing the means of processing and transmitting/receiving Trading orders and the means of effecting Trading transactions, where according to the invention hardware and software complex additionally contains the Module of generation and analysis of trading orders (hereinafter—GATO Module), connected to the Manager Module and the User Module, and made so as to enable acceptance, analysis and adjustment of Trading orders, generated by the Manager Module, and their potential translation to the User Module to effect respective Trade transactions on the User's Account; it also includes a receive component, an analysis component, which is designed so that it provides an opportunity of dynamic expansion of the base of applied algorithms, an adjustment component, a generation component, a translation component and a statistic data processing component regarding the Manager Trading transactions and Trading orders.

Moreover, the means of the Manager Module include a Manager's Account component, which may be virtual and have no marginal requirements and commissions.

Moreover, the Manager Module includes the means of transmitting data to generate the list of Managers.

Moreover, the means of the User Module include the component of selecting one Manager or the list of Managers, whose Trading orders may be translated to the User's Account via the GATO Module.

Introduction into the suggested system of the additional module of generation and analysis of Trading orders provides an opportunity to lower User's risks, connected with the effect of Trading orders, generated by the Manager, on the User's Account.

The list of terms and definitions used in this application is given below:

Trading platform is a hardware and software complex, ensuring transmission, formation of information under a preset algorithm and the effect of Trade transactions in accordance with Trading orders. The Trading platform is used by the Manager and the User.

The Trading platform, used by the Manager, provides an opportunity to the Manager of Trade transactions on the Manager's Account to transform Trading orders into the format acceptable for GATO Module. The Trading platform, used by the Manager, sends Trading signals to the GATO Module.

The Trading platform, used by the User, performs the function of carrying out a Trading order on the User's Account, translated by the GATO Module.

The Trading platform changes User interface depending on the account in operation—Manager's Account or User's Account.

Trading order comprises data in any form, containing information on the kind and volume of initiated Trading transaction.

Trading transaction is a purchase or sale of a financial instrument or instruments on financial markets.

Volume of a Trading transaction is the quantity index of the Trade transaction, determining the volume of purchased or sold financial instrument during a trading transaction. The volume of the Trading transaction shows the funds, involved into the Trading transaction.

Generation of a Trading order is creation of a Trading order by indicating information on a Trading transaction.

Processing a Trading order is a complex of actions on accepting a Trading order and further analysis and translation of the Trading order.

Receiving a Trading order is an action to receive a Trading order, generated by the Manager in any form.

Analyzing a Trading order is an action to make a decision on further potential translation of the Trading order, and in case of the positive decision—potential change of features of the Trading order.

Translating a Trading order is an action to translate the Trading order.

### BRIEF DESCRIPTION OF THE DRAWINGS

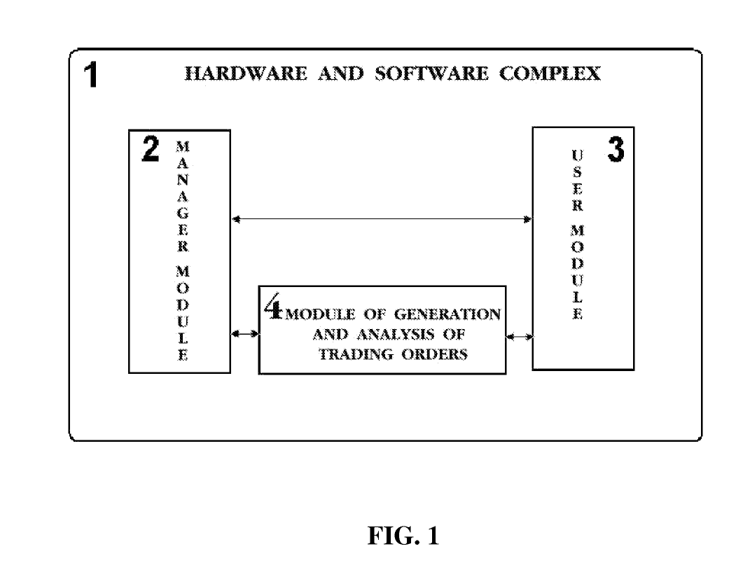

The overall procedure of the suggested management system for electronic trade of financial instruments of the complex is given in FIG. 1, where: 1—hardware and software complex, 2—Manager Module, 3—User Module, 4—Module of generation and analysis of trading orders.

### DETAILED DESCRIPTION OF THE PREFERRED EMBODIMENTS

Hardware and software complex 1 includes Manager Module 2, User Module 3 and Module of generation and analysis of trading orders 4. All modules are interrelated.

Manager Module 2:

1. contains the means of processing and transmitting/receiving Trading orders and the means of effecting Trading transactions.

2. contains a Manager's Account component, which may be either real or virtual, may or may not have any marginal requirements and commissions.

3. provides the Manager with an opportunity to generate Trading orders by effecting Trading transactions. Therewith actual purchase or sale of a financial instrument on his account does not occur. When determining the Volume of a Trading transaction the Manager uses Lots.

A Lot is a symbol used to identify the unit of quantitative evaluation of the Volume of a Trading transaction. When indicating the Volume of a Trading transaction, the Manager may vary the size of the Lot within the preset limits (including—effect of the Trading transaction with two or more Lots, or a part of one Lot).

A point is a symbol used to show the difference between the price of the financial instrument at the time of effecting a Trading transaction and the price of the commercial instrument while effecting the Corresponding commercial transaction (opposite: under the purchase—sale, under a sale—purchase). The value of points may be either positive or negative.

While generating Trading orders it does not matter what factors the Manager followed to, and what additional means were involved into effecting the Trading transaction (the Manager may personally indicate the volumes of Trading transactions, their types etc., use automatic and automated methods of Trading transactions, or combines these methods).

4. transmits to the GATO Module information to generate the list of Managers. The list of Managers is a general term for a group of Managers, created on the basis of a number of factors. The lists of Managers are generated basing on any properties of the Managers. Generation of the lists of Managers (their grouping) is based on the statistical data, contained in their Trading orders, as well as Additional information, characterizing the Manager—a number of other factors, (background of his Trading transactions, their periodicity etc.).

User Module 3:

1. contains the means of processing and transmitting/receiving Trading orders and the means of effecting Trading transactions.

2. includes the User's Account:

The User's Account is used to effect Trading orders of the system on it via the Trading platform.

The User's Account implies keeping User's funds in the way enabling to use these monetary funds to effect Trade transactions where they are involved.

The effect of the System Trading orders is automatic effect of Trading transactions by the Trading platform involving the User's funds pursuant to the Trading order, received under translation of the Trading order by the GATO Module, or of the Trading order, generated by the GATO Module.

3. Using the means of this module, the User makes choice (identification, use) of the List of Managers. This action is performed by the User in any form (including filling in applications, special forms, in soft or hard copies with or without using the Trading platform), its aim is to identify the group of Managers, whose Trading orders will be translated by the GATO Module to the User's Account via the Trading platform. When the User selects the List of Managers, the GATO Module automatically determines the Manager, or a group of Managers, included into the List of Managers, selected by the User, whose Trading orders will be translated by the System to the User's Account via the Trading platform. The User may perform the action similar to selecting the list of Managers to choose specific Managers to translate their Trading orders only, by indicating specific Managers and identifying the amount on the User's Account to be involved in the effect of Trading orders, received from the GATO Module.

While selecting the Group of Managers, the User indicates the amount of funds on the User's Account, to be involved in effecting Trading transactions under the effect of the System Trading orders by the Trading platform.

4. The User Module may transmit data to the GATO Module.

Functions of GATO Module 4:

1. receive Trading orders, generated by the Manager Module, further analyze them under preset algorithms, and, if required, adjust them. Provided no need to adjust a Trading order, it is translated to the User Module.

2. translate Trading orders to the User Module to carry out correspondent Trading transactions on the User's Account.

Therewith the GATO Module includes:

a receive component;

an analysis component, which is designed so that it provides an opportunity of expansion of the base of applied algorithms,

an adjustment component,

a generation component,

a translation component

a statistic data processing component regarding the Trading transactions and Manager Trading orders.

The adjustment component is made to enable:

Blocking a Trading order;

Changing a Trading order.

An adjusted Trading order is translated via the translation component to the User Module.

Trading orders may also be generated in the GATO Module (in cases, determined under a special algorithm) using the generation component and translated to the User Module via the translation component.

The components of analysis, adjustment, generation and statistical data processing, included into the GATO Module, may be entire, interrelated, made either on the basis of the unified hardware and software complex, or be separate module/modules with the function of receiving and sending Trading orders and other data from the User Module, the Manager Module and the GATO Module. Besides, the components of analysis, adjustment, generation and statistical data processing, included into the GATO Module, may be a part of the User Module and the Manager Module, saving their functions of receiving and sending Trading orders and other data from the User Module, the Manager Module and the GATO Module.

The claimed management system for electronic trade of financial instruments may be performed on the basis of various computer systems.

On the whole the system allows to solve the issue of increasing the efficiency of User's management of his funds by reducing the human factor, lowering risks and increasing profitability rate under effecting Trading orders generated by the Manager on the User's Account.

What is claimed is:

1. A management system for electronic trade of financial instruments implemented as a hardware and software complex comprising:
at least one manager module comprising
a means for generating and transmitting trading orders; and
at least one user module comprising
a means for accepting trading orders and
a means for effecting trading transactions;
wherein the at least one manager module and the at least one user module are connected;
wherein the hardware and software complex further comprises at least one trading order generation and analysis module connected with the at least one manager module and the at least one user module;
capable of receiving, analyzing, and adjusting trading orders generated by the at least one manager module;
capable of generating trading orders and transmitting trading orders to the at least one user module to effect corresponding trading transactions on a user's account; and
comprising
a reception unit,
an analytic unit capable of dynamically expanding a set of algorithms in use,
an adjustment unit,
a generation unit,
a transmission unit, and
a statistic data processing unit for manager's trading transactions and manager's trading orders.

2. The system according to claim 1, wherein the at least one manager module further comprises a manager's account unit capable of being virtual and having no margin requirements and commissions.

3. The system according to claim 1, wherein the at least one manager module further comprises a means for transmitting data to generate a list of managers.

4. The system according to claim 1, wherein the at least one user module further comprises a unit for selecting one manager or a list of managers, whose trading orders are capable of being transmitted to the user's account via the at least one trading order generation and analysis module.
